(19) United States
(12) Patent Application Publication
(10) Pub. No.: US 2013/0080338 A1
(43) Pub. Date: Mar. 28, 2013

(54) IDEAS PROMOTED TO PROJECTS AND SYNCHRONIZATION OF STATUS INFORMATION

(71) Applicants: Daniel C. Broekman, Bellevue, WA (US); Amy Elizabeth Glaves, Marysville, WA (US); Pradeep GanapathyRaj, Bellevue, WA (US); Richard Eric Witte, Duvall, WA (US); William R. Avery, Redmond, WA (US); Yuka Sanada, Bellevue, WA (US)

(72) Inventors: Daniel C. Broekman, Bellevue, WA (US); Amy Elizabeth Glaves, Marysville, WA (US); Pradeep GanapathyRaj, Bellevue, WA (US); Richard Eric Witte, Duvall, WA (US); William R. Avery, Redmond, WA (US); Yuka Sanada, Bellevue, WA (US)

(73) Assignee: MICROSOFT CORPORATION, REDMOND, WA (US)

(21) Appl. No.: 13/247,908

(22) Filed: Sep. 28, 2011

(51) Int. Cl. G06Q 10/06

(52) U.S. Cl. 705/300

(57) ABSTRACT

Embodiments are provided that include creating projects based in part on a number of collaborative list items and mapping information, but are not so limited. In an embodiment, a computing environment includes a project management system and a collaboration system that are used in part to manage an ideation to project creation process based in part on mappings used to map collaboration information between the collaboration system and the project management system. A method of an embodiment includes the use of mapping information and/or settings in part to create new projects from collaborative list items, wherein a project creation process includes copying over list item values according to the mapping information, storing an identifier of a collaborative list item in each created project, and/or storing an identifier of a created project as part of a corresponding list item. Other embodiments are also disclosed.

### BACKGROUND

Project management systems provide a number of project management and tracking tools, but have no easy or lightweight way to manage an ideation creation and generation process due in part to the limited user access conditions (e.g., project manager access only). Ideation can be described as a process of using wisdom of a group of individuals in attempts to generate valuable collaborative project ideas. For example, a patent incentive program may entice enterprise employees to submit, comment, and vote on ideas, after which project managers review the entries and decide which ideas to pursue as full-fledged projects.

Collaboration systems, on the other hand, provide a natural place to impart ideation processes due in part to access and management abilities offered to multiple users, richer customization options, and a more lightweight solution than project management systems. Additionally, the project management systems are often segregated and detached from the collaboration systems and typically require many manual work hours in attempting to connect an ideation process managed in a collaboration system with a project management process using the project management system.

As one example, a current limited and inefficient method requires that project managers manually create new project entries for each new idea they want to turn into a project, including copying and pasting the relevant data which often results in a very time-consuming and error-prone manual entry and configuration process. Another drawback results in that once a project has been created in the project management system, there is no easy way for a project manager to update an associated project status in a collaboration system. Users who do not have access to the project management system (including potentially the creator of the original idea) are left in the dark about the progress of the project, unless the project manager takes the time to manually update status in both systems.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided that include creating projects based in part on a number of collaborative list items and mapping information, but are not so limited. In an embodiment, a computing environment includes a project management system and a collaboration system that are used in part to manage an ideation to project creation process based in part on mappings used to map collaboration information between the collaboration system and the project management system. A method of an embodiment includes the use of mapping information and/or settings in part to create new projects from collaborative list items, wherein a project creation process includes copying over list item values according to the mapping information, storing an identifier of a collaborative list item in each created project, and/or storing an identifier of a created project as part of a corresponding list item. Other embodiments are also disclosed.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing environment including collaboration and project management features.

FIG. 2 is a flow diagram illustrating an exemplary process of creating one or more projects from one or more list items.

FIG. 3 is a block diagram of an exemplary computing environment that includes functionality to create projects from collaborative list items.

FIGS. 4A-4G depict an example user interface (UI) that can be used as part of creating projects from list items.

FIG. 5 is a block diagram illustrating an exemplary computing environment for implementation of various embodiments described herein.

### DETAILED DESCRIPTION

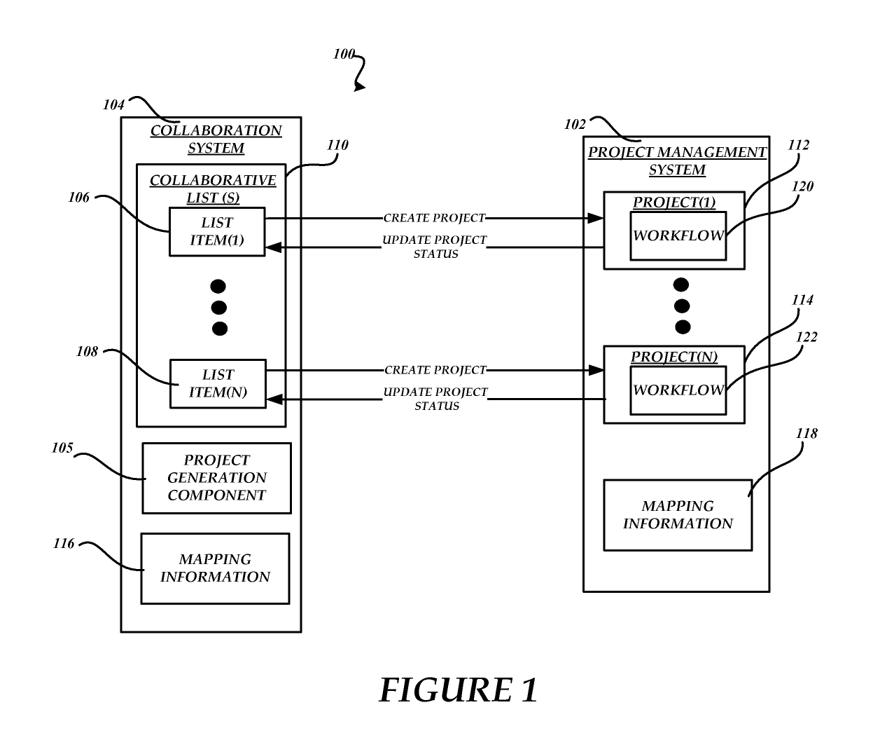

FIG. 1 is a block diagram of an exemplary computing environment 100 that includes processing, memory, and other components that provide idea collaboration and project management features, but is not so limited. For example, components of the computing environment 100 can be used to provide ideation processing and project generation features as part of an idea creation and management process integrated with a project management process. As shown in FIG. 1, the exemplary computing environment 100 includes a project management system 102 and a collaboration system 104, but is not so limited. Those skilled in the art will recognize that a plurality of client devices/systems can be configured to communicate and/or interact with the project management system 102 and collaboration system 104 using wireless and/or wired infrastructure.

The collaboration system 104 can include functionality to provide collaboration services to associated users, while the project management system 102 can include functionality to create and manage projects. As described below, the environment 100 can be used as part of an ideation process to collaborate and generate ideation information to create project information and a number of associated projects. The project generation component 105 of an embodiment resides in the collaboration system 104 and operates in part by creating new projects in the project management system 102 based in part on mappings between list items (e.g., list items 106, 108) of a collaborative list 110 managed by the collaboration system 104. It will be appreciated that there may be large numbers of lists and/or projects. As shown as an example, the project generation component 105 has created a plurality of projects in the project management system 102, including a new project 112 based in part on aspects of list item 106, and a new project 114 based in part on aspects of list item 108.

The project generation component 105 uses mapping information 116 as part of creating the projects in the project management system 102. In one embodiment, the mapping information 116 and/or mapping information 118 provides mappings between fields of collaborative list 110 and fields on a project object of a project server. The project generation component 105 is configured in part to map fields from a collaborative list to any arbitrary project-level field in the project management system 102, including mapping to new and custom fields. For example, mappings can be defined between a list's columns and corresponding fields in a project web access application, including intrinsic fields and custom fields, and used when creating a new project from a list item as part of a manual or automatic project generation process.

The mapping information 116 of an embodiment stores field mapping parameters with the collaborative list 110, enabling the project generation component 105 to create one or more projects using one or more list items, including subsequent creation of new projects based in part on list items. In an embodiment, the project generation component 105 can be configured to create projects from ideas generated from an ideation process managed using aspects of the collaboration system 104. A project workflow or workflow existing in the project management system 102 and running on published or promoted projects can be used to update project progress in the collaboration system 104 and/or collaborative list 110. The project generation component 105 can also be configured to map fields between the project management system 102 and the collaboration system 104. For example, a project workflow 120 can be used to update a field or fields of list item 106 and a project workflow 122 can be used to update a field or fields of list item 108 when updating project progress to the collaborative list 110. Thus, aspects of a collaborative list can be automatically updated using a project-based workflow.

As described below, list items, including data and/or metadata, can be used to create projects, including through the use of manual input and/or the use of an encoded workflow associated with a designated collaborative list. As an example, a list workflow can be used to automatically generate one or more projects based in part on some defined criteria (e.g., number of votes, clicks, etc. exceeded some threshold) using field mappings and/or other settings associated with a number of list items. In one embodiment, a project creation process includes copying over the corresponding list item values according to the mapping information 116, storing an identifier (e.g., globally unique identifier (GUID)) of a collaborative list item in a new project, and/or storing an identifier (e.g., GUID) of the new project as part of the corresponding collaborative list item (e.g., a list item field). For example, a user can use a computer browser to create and manage collaborative idea lists, including the generation of new projects from idea list items and/or a list workflow, and/or use the new projects.

The project generation component 105 of one embodiment comprises encoded instructions included as part of a computer-readable medium that can be executed to: create a representation of an idea based in part on the use of a web ID, collaborative list ID, list item ID, and/or a corresponding project type ID (e.g., enterprise project type ID); validate that a list item or idea has not already been promoted to a project; generate a project data set to be used to create the project including, but not limited to, setting up links to the idea list entry (e.g., web ID, list ID, and/or item ID) in a new project, analyzing mappings or mapping information for an associated list or list item including checking a data type of each field, and/or converting each list item value/field appropriately; ensure that a new project name is unique; call project queuing and/or publishing methods (e.g., the QueueCreateProject and QueuePublish methods); and/or write a resulting project identifier (e.g., Proj_uid) to a corresponding list item.

Suitable programming means include any means for directing a computer system or device to execute steps of a method, including for example, systems comprised of processing units and arithmetic-logic circuits coupled to computer memory, which systems have the capability of storing in computer memory, which computer memory includes electronic circuits configured to store data and program instructions. An exemplary computer program product is useable with any suitable data processing system. While a certain number and types of components are described, it will be appreciated that other numbers and/or types and/or configurations can be included according to various embodiments. Accordingly, component functionality can be further divided and/or combined with other component functionalities according to desired implementations.

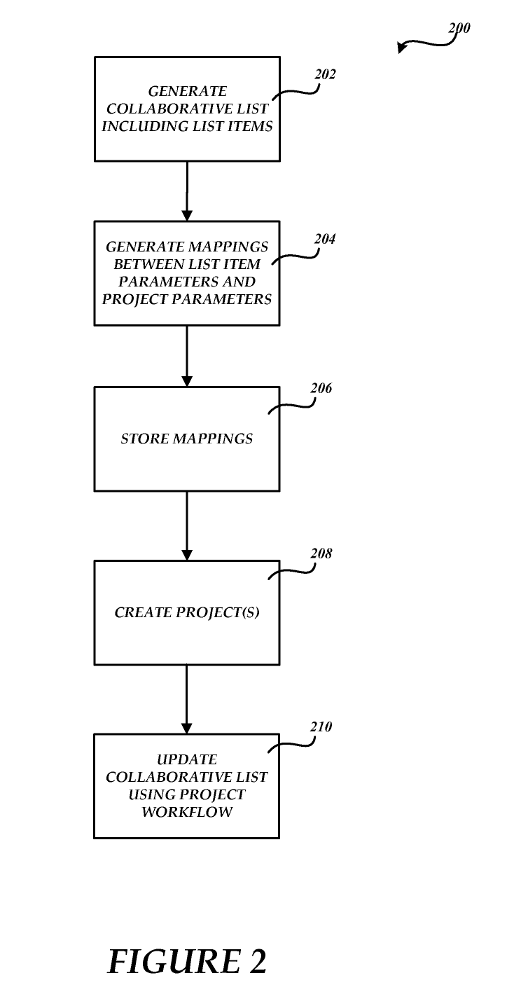

FIG. 2 is a flow diagram illustrating an exemplary process 200 of creating one or more projects from one or more list items. For example, a number of projects can be created using a collaborative idea list that includes a number of ideas, wherein each idea is used to generate a corresponding project. At 202, the process 200 operates to generate a collaborative list that includes a number of list items. For example, a user can use a browser component to access collaborative services that enable creation of collaborative lists that can be shared and/or used to create new projects.

At 204, the process 200 of an embodiment operates to generate a mapping between selected list parameters and corresponding project fields. For example, a user can use a mapping dialog accessed using the browser component to manually map list columns of a collaborative list to project fields of a new project as part of generating a customized project according to the defined mappings. As another example, a list workflow can be used to automatically use a default mapping when generating projects from list items. At 206, the process 200 stores the mappings. For example, mapping information can be stored in a collaboration system and/or project management system and/or some other system or component. The mapping information can also be shared by different systems/users.

At 208, the process 200 operates to create one or more projects based in part on the number of list items of the collaborative list. For example, a user can define (e.g., select) which list items are to be used when creating projects. The process 200 of an embodiment at 208 operates to validate list column to project field mappings, including taking any corrective action(s), before creating a project in a project server. At 210, the process 200 operates to update one or more list item parameters using a project workflow. For example, a project workflow can be used to update a list parameter corresponding to status of a newly created and/or modified project. Mapping information can also be updated or modified as part of updating project and/or list item parameters.

It will be appreciated that processing and/or networking features can assist in providing project creation and list-project synchronization features. Aspects of the process 200 can be distributed to and among other components of a computing architecture, and client, server, and other examples and embodiments are not intended to limit features described herein. While a certain number and order of operations is described for the exemplary flow of FIG. 2, it will be appreciated that other numbers and/or orders can be used according to desired implementations.

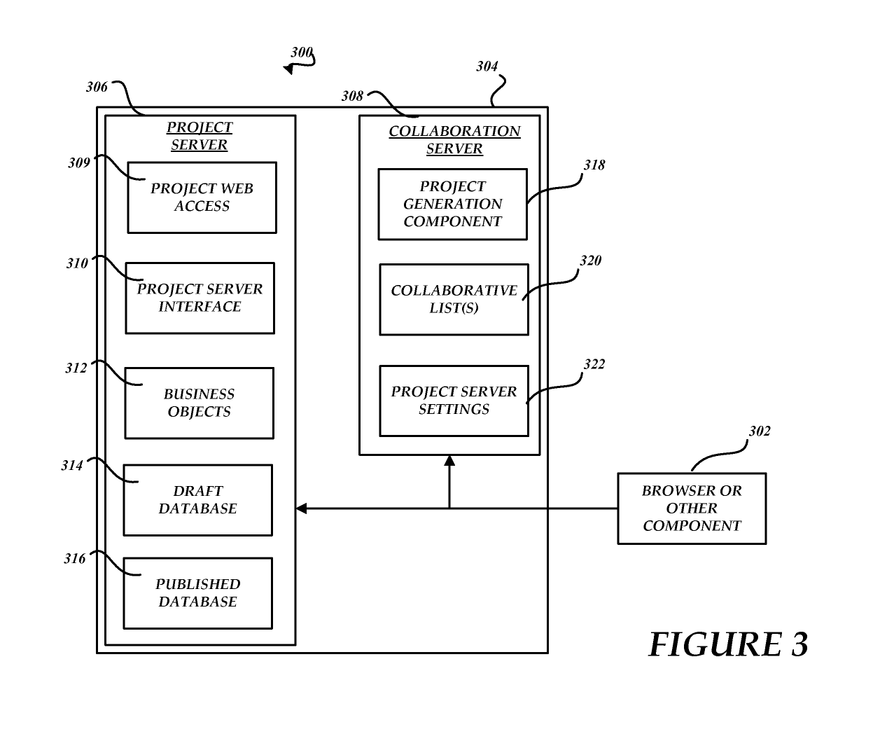

FIG. 3 is a block diagram of an exemplary computing environment 300 that includes functionality to create projects from collaborative list items, but is not so limited. As shown, a browser or other component 302 is in functional communication with a system 304 that includes a project server 306 and a collaboration server 308, but is not so limited. It will be appreciated that other user devices/systems can be included that couple, communicate, and/or interact with one or more components of the environment 300 as part of providing collaborative idea and project creation functionality. Moreover, each server may include multiple physical serving machines, including co-location, remote-location, and/or distributed architectures.

An end-user may or may not have permissions to use each feature of the project server 306 and collaboration server 308. For example, a user may have permission(s) to use features of the collaboration server 308 to create projects from collaborative items contained in an idea list, but lack permission(s) to modify a project on the project server 306 once created. As another example, users may have permission to suggest an idea, but not to create a project from that idea. End-users can use different browser applications, such as those used with a smartphones, laptop computers, tablet computers, desktop computers, and/or other computer/communication interface can be used access features of the environment 300.

As described in detail below, components of the exemplary computing environment 300 provide an ability to promote collaborative list items (e.g., SHAREPOINT list items) included in the collaboration server 308 to projects included in the project server 306 (e.g., a dedicated project management server or servers). The promotion operations can be used as part of tracking and executing projects associated with an idea collaboration process, including manual promotion capability, and/or automatic promotion capability using a list-based workflow (e.g., SHAREPOINT workflow).

As shown, the project server 306 includes a project web access (PWA) component 309, a project server interface (PSI) component 310, and/or business objects 312 that include projects, tasks, resources, assignments, etc. The project server 306 infrastructure also includes a draft database 314 and a published database 316. The draft database 314 can include projects yet to be included in the published database 316. The collaboration server 304 includes a project creation component 318, collaborative lists 320, and a project server setting component 322 (e.g., browser page) used in part to store a default field mapping for a list. As described above, collaborative list items, such as collaborative ideas, can be used to generate corresponding projects that can be tracked in both the project server 306 and collaboration server 304.

A project creation process of an embodiment includes defining mappings (e.g., manually and/or automatically) between columns of a collaborative list and project fields, and using an automatic copy operation to copy over data from a list item into a corresponding project based on the mapping. Parameters associated with new projects and/or associated lists/list items can be maintained and/or updated as part of synchronizing and/or updating operations. In an embodiment, control input, by a project manager or other user for example, can be used to automatically update a status column in the collaborative list from a workflow running on the corresponding project (e.g., a project workflow). As an example, components of the computing environment 300 can be used as part of providing demand management (DM) services including collecting demand (e.g., project ideas and/or proposals), gathering features on the proposals when managing using a portfolio management operation (e.g., a triage and/or selection workflow), and/or project executing and tracking using a component or component of the project server 306 (e.g., project management application and/or server).

In an embodiment, components of the exemplary computing environment 300 provide an integrated, easy-to-use infrastructure that provides a method to promote collaborative list items of a collaborative list to projects in a project management application and/or server, but is not so limited. Projects and the associated promoted ideas can be tracked and/or executed by project managers and/or other users/systems/components. As described briefly above, functionality of the exemplary computing environment 300 allows for the specification of a mapping between columns of a collaborative list to fields in project management server, laying the source to target copy mappings to copy over data from a list item to a new project, enabling multiple project fields to be instantly populated.

As an example, mappings, including default and custom mappings, between items in a collaborative list can be pre-generated, such as before project promotion time for example, or can be automatically saved the first time a list item is manually promoted. As described above, the mapping functionality can be enabled both manually (e.g., using SHAREPOINT list view UI) as well as automatically (e.g., using SHAREPOINT workflow on the list of ideas). For example, a manual mapping process can use manual field mapping inputs, including selection of an enterprise project type of the project to be created to indicate a project workflow to start on a new project.

An existing field mapping can be automatically loaded to allow the user to quickly create additional projects. When automatically triggered using a list-based workflow (e.g., a SHAREPOINT workflow), an existing field mapping (e.g., default based on prior mapping to same data type) can be used when promoting list items to corresponding projects. If no mapping exists, a promotion method of one embodiment operates to promote a title field of a list item to be a project name of a new project created for the list item. For example, as part of an idea promotion methodology, certain ideas can be promoted based in part on a potential added value resulting from pursuing a new project.

In an embodiment, the project server 306 is configured to enable users to update a status column of a collaborative ideas list by using a new project workflow or activity. Based in part on the mappings and the knowledge of the project server 306 with respect to a location of the list item of the collaborative list that was used to create a corresponding project, the list item can be updated with a custom status, as specified by the project workflow author for example. A value of the custom status can range from a hardcoded value indicating the stage of the workflow to a custom message based on the value of a field in the project. Components of the exemplary computing environment 300 provide features and functionality that include generating, storing, and/or managing item list to project field mappings, increasing two-way interaction between a project and the list item or items after promotion, and/or flexibility of using different promotion use cases, such as manual promotion and/or using a list workflow to automatically promote a list item or items as examples.

As an example, the exemplary computing environment 300 can be implemented as part of enabling an additional lightweight ideation phase before a proposal phase of portfolio management process. For example, an enterprise user can use a browser or other application to create and/or access a SHAREPOINT list of ideas as part of creating projects in the project server 306 using triaged list items from the collaboration server 308. Thus, as one example, any permitted collaborative list user can create and collaborate on ideas, while one or more project managers who are project server users can triage the ideas and push certain ones into project server for follow-up, tracking, and execution. Users thereby obtain the power and value of a project management server, such as optimization, scheduling, etc., including an ability to initiate the process by collecting ideas in a collaboration system, such as a SHAREPOINT server farm for example.

For example, the components of exemplary computing environment 300 provide the infrastructure to grow ideas using a collaboration server to create projects in a project server, leaving an ideation process or methodology up to the user to define. Users can access the ability to make the ideation and project creation process as simple or powerful absent prescribing a specific list type to use or workflow to follow. For example, voting and commenting information associated with list items can be used by a project manager to triage a list of ideas. In an embodiment, a user can use a browser application or interface to leverage the features and functionality of the exemplary computing environment 300, including existing and/or future standards, cross-browser compatible markup, etc.

As described above, one or more projects can be created based on a collaborative list including one or more list items, but is not so limited. In an embodiment, a project creation component 318, including encoded instructions that can be processed to provide various features, is configured to create individual projects for designated (e.g., selected) list items of a collaborative list. For example, the project creation component 318 can use a create project from list item method (e.g., Public Guid CreateProjectFromListItem(GUID, webID, GUID listID, int itemID, GUID EPTID) as part of creating new projects from list items.

The project creation component 318 of an embodiment operates to 1) create a representation of an idea that includes a web ID, a list ID, a list item ID, and/or an associated project type ID (e.g., enterprise project type ID); 2) validate the idea including ensuring that the idea is not already a promoted project; 3) generate and fill a project data set to be used to create the project, including, but not limited a) setting up links to the idea list entry (e.g., webID, list ID, and item ID) in the new project, and/or b) analyzing mappings or mapping information for the list, performing field filling operations including i) checking each field's data type, and converting each list item value/field appropriately and/or ii) removing invalid characters and/or truncating a name of the project if necessary and/or if no field is specified for name, then use the title field of list item as the default name; 4) ensure the name of the project is unique; 5) call project queuing and/or publishing methods (e.g., the QueueCreateProject and QueuePublish methods); and/or 6) write the resulting project identifier (e.g., Proj_uid) to the list item.

Example code portions that can be used to create a project from a collaborative list include:

```
      /// <summary>
      /// Creates a new project from a SHAREPOINT list item using the specified EPT.
      /// </summary>
      /// <param name=“webId”>ID of the site (SPWeb) containing the list</param>
      /// <param name=“listId”>ID of the list (SPList) containing the item</param>
      /// <param name=“itemId”>ID of the item (SPListItem) within the list</param>
      /// <param name=“eptId”>UID of the enterprise project type</param>
      /// <returns>UID of the newly created project.</returns>
      public Guid CreateProjectFromListItem(Guid webId, Guid listId, int itemId, Guid
eptId)
      {
        IdeasListItem idea = new IdeasListItem(webId, listId, itemId);
        ProjectDataSet pDS = new ProjectDataSet( );
        ProjectDataSet.ProjectRow projRow = NewProjectRow( );
        projRow.ENTERPRISE_PROJECT_TYPE_UID = eptId;
        projRow.PROJ_UID = Guid.NewGuid( );
        // Setup the link to the SP idea list entry.
        projRow.IDEA_WEB_UID = idea.WebId;
        projRow.IDEA_LIST_UID = idea.ListId;
        projRow.IDEA_ITEM_ID = idea.ItemId;
        projRow.PROJ_NAME = ScrubProjectName(idea[TitleFieldName] as string);
        pDS.Project.AddProjectRow(projRow);
        Dictionary<string, string> mappings = idea.XmlMappings;
        foreach (string psId in mappings.Keys)
        {
            string spId = mappings[psId];
            object spValue = idea[spId];
            SharePointType spType = idea.GetSPType(spId);
            if(psID is a Guid)
            {
                //fill in the custom field value
                CustomFieldDefinition cf = ReadCustomField(psID);
```

| | |
|---|---|
| ProjectCustomFieldsRow row | = |

```
NewProjectCustomFieldsRow( );
                row.MD_PROP_UID = cf.MD_PROP_UID;
                row.PROJ_UID = projRow.PROJ_UID;
                row.FIELD_TYPE_ENUM = cf.MD_PROP_TYPE_ENUM;
                CustomFieldType toConvertTo = row.FIELD_TYPE_ENUM;
                row.Value = ConvertSPFieldTypeToProjectType(toConvertTo,
spValue, spType);
                pDS.AddProjectCustomFieldsRow(row);
            }
            else
            {
                // otherwise it is the name of an intrinsic field
```

| | |
|---|---|
| ProjectType toConvertTo | = |
| pDS.Project.Columns[psId].DataType; | |
| projRow[psId] | = |
| ConvertSPFieldTypeToProjectType(toConvertTo, spValue, spType); | |
| } | |
| } | |
| QueueCreateProject(projRow.PROJ_UID, pDS); | |
| QueuePublish(projRow.PROJ_UID); | |
| // Write back the PROJ_UID to the list item. | |
| idea.ProjectUid = projRow.PROJ_UID; | |
| return projRow.PROJ_UID; | |
| } | |

Once a new project is created, including the mappings defined between list items and corresponding project fields, the information in the collaborative server 308 can be updated to reflect project-related changes/updates. For example, an idea list item property associated with a new project can be updated as parameters of the project change. In an embodiment, a workflow action can be used to update a collaborative idea list with a project status that references the mapping between the project and idea. For example, the workflow action can be surfaced in SHAREPOINT designer (SPD) and Visual Studio.

In an embodiment, an update activity can be called inside of a workflow on the project web access site, wherein the ideas list is included in the same site collection as the project web app (project web access) site. By default, the workflow can be configured to impersonate a project manager who initiated the workflow when the project was created by having a project server push back a current status and/or any other data and set a field in the list. In an embodiment, the project server 306 can be configured to use a mapping database or other data structure to look up or identify a list item ID associated with a given project and use the lookup information to push the data to the corresponding collaborative list in the collaboration server 308. Thereafter, the collaborative list data can be updated in part using the collaborative object model implemented in the environment 300 (e.g., SHAREPOINT object model).

In an embodiment, a project can be created and updated using encoded instructions that operate in part to map collaborative list items to corresponding new projects and update collaborative list item parameters. For example, collaborative list data can be updated in part using an update idea list item status method (e.g., Public void UpdateIdeaListhemStatus(GUID projectID, string status)). The update idea list item status method of an embodiment operates to: ensure that a user has permission to open a particular project; read the project web ID, list ID, and/or item ID properties; and/or use the project web ID, list ID, and/or item ID properties to access the specified list and list item and set (and add if necessary) the idea list item status column's value to the specified status.

Example code portions that can be used to update collaborative list data include:

```
      /// <summary>
      /// Update the original ideas list item that
CreateProjectFromListItem used to create the project
      /// </summary>
      /// <param name=“projectId”>ID of the project</param>
      /// <param name=“status”>Status message that can be written to the
idea status column</param>
      public void UpdateIdeaListItemStatus(Guid projectId, string status)
      {
        ProjectDataSet projDSet = ReadProject(projectId);
        ProjectDataSet.ProjectRow pRow = projDSet.Project[0];
        Guid webId;
        Guid listId;
        int itemId;
        if (ValidateIdeaListProjectRow(pRow, out webId, out listId,
        out itemId))
        {
            IdeasListItem idea = new IdeasListItem(webId, listId,
            itemId);
            idea.ProjectStatus = status;
        }
      }
```

List to project mapping information can also be stored, managed, and/or updated as part of keeping the collaborative and project-related operations up to date. For example, mapping information between items of a collaborative list and fields of a newly created project can be stored as part of computer storage, such as by using a database server or other storage medium to manage updates. In an embodiment, the mapped collaborative list columns to project server custom fields can be stored in a computer readable medium, such as one or more mapping database structures for example. In one embodiment, mapping information can be stored in a property bag associated with the collaborative list (e.g., located in the SPList.RootFolder.Properties as a hash table). The project server fields of an embodiment include custom fields and/or intrinsic fields of a project (e.g., project name, start date, finish date, author, project owner, etc.). Mapping information can reflect a mapping to a custom field where the ID is the GUID. Mapping information can also reflect a mapping to an intrinsic field, storing the column name from the corresponding project table (e.g., MSP_PROJECTS table).

The SPField ID of an embodiment comprises the internal name of the field: SPField.InternalName. As an example, the project server custom field IDs are GUIDs, and intrinsic field IDs correspond with the column names.

Key=ProjectFieldMappings

Value=An XML document with following schema:

<Mapping>

<Field SP=“SPField1 Id” PS=“PSField1 Id”/>

<Field SP=“SPField2 Id” PS=“PSField2 Id”/>

. . .

</Mapping>

Storing mapped list item (e.g., an idea type) parameters to project server parameters of an embodiment comprises storing each list item to project mapping in a project server to allow for the project server to update the project status for a corresponding list item which can be communicated to the collaboration system 302. In one embodiment, the updating can be performed by a project server workflow hosted in a site collection. In one alternative embodiment, mapping information can be stored in the collaborative server 304, allowing a list to push updates associated with a list item to the project server. When updated, a mapping can be updated in both systems synchronously, asynchronously, etc. Changes made to parameters associated with a mapping can be managed and/or updated at various times.

As part of a promotion operation, when a collaborative list item is promoted in the project server 306, the list item's ID can be stored in a corresponding project table (e.g., MSP_PROJECTS table). As an example, the table below shows a number of columns that can be included as part of a projects table (e.g., MSP_PROJECTS table):

| | | Allow | | |
|---|---|---|---|---|
| Column Name | Data Type | Nulls | Default Value | Purpose |
| SP_IDEA_LIST_SITE_NAME | nvarchar(260) | Yes | NULL | Stores the relative |
| | | | | URL to the subsite |
| | | | | containing the Ideas |
| | | | | List |
| SP_IDEA_LIST_ID | uniqueidentifier | Yes | NULL | Stores the GUID of |
| | (UID) | | | the Ideas List, |
| | | | | corresponding to |
| | | | | SPList.ID |
| SP_IDEA_LISTITEM_ID | Int | Yes | NULL | Stores the ID of the |
| | | | | list item that was the |
| | | | | source for the new |
| | | | | project, corresponding |
| | | | | to SPListItem.ID. |
| | | | | This id is only unique |
| | | | | within the SPList and |
| | | | | not a GUID. |

Exemplary methods can also be configured and used to manipulate list item and project-related mappings. For example, a load mappings method (e.g., LoadMappings( )) can operate to query a collaborative list's properties (e.g., SHAREPOINT list properties) for project field mappings (e.g., ProjectFieldMappings). If the project field mappings exist, the method can operate to parse any extensible markup language (XML) and/or any other information. As another example, a save mappings method (e.g., SaveMappings( )) operates to write the specified mappings in XML and/or other format(s) to the collaborative list's properties associated with the project generated from the collaborate list.

Exemplary conversion methods can be configured and used for various data types. The conversion methods of an embodiment are encoded as part of the functionality of the project server 306 and associated with a PSI component 310 call (e.g., CreateProjectFromListItem). A PSI method of an embodiment manages any conversion operations. A number of exemplary conversion methods are described below, all types not described here can be blocked and an error can be returned if attempting to convert the non-described types.

Exemplary conversion methods include, but are not limited to: Integer To Number (Decimal, double, float, int, . . . ); Text To Text; Note To Text; Date/Time To Date (The Date_Value in Date is implemented as a DateTime); Choice To Text; Boolean To Flag; Number To Number; Currency To Cost (Currency extends Number, and adds CurrencyLocalId that is used to format value, and position the currency symbol and Cost: CustomField.Type enum; Project.CurrencySymbolPosition enum defined by culture in use in the project); URL To Text; User To Text; Lookup To Text; MultiChoice To Text; UserMulti To Text; Lookup Multi To Text; Calculated To Text (e.g., a calculated field using an excel-like formula—the value can be computed when the list item is inserted or modified, import/copy the formula (s), etc.); ContentTypeId To Text; and/or GUID To Text, etc.

In an embodiment, type equivalencies can be used as illustrated in the following table.

| Collaborative | | Mapped to project |
|---|---|---|
| FieldType | Description | server field type |
| Integer | Specifies positive or negative integer values. | Number |
| | Corresponds to the Integer field type that is | |
| | specified on the Field element. | |
| Text | Specifies a single line of text. Corresponds to the | Text, single-line |
| | SPFieldText class and to the Text field type that | |
| | is specified on the Field element. | |
| Note | Specifies a field that can contain multiple lines of | Text, multi-line |
| | text. Corresponds to the SPFieldMultiLineText | |
| | class and to the Note field type that is specified | |
| | on the Field element. | |
| DateTime | Specifies date and time values. Corresponds to | Date |
| | the SPFieldDateTime class and to the DateTime | |
| | field type that is specified on the Field element. | |
| Choice | Specifies a predetermined set of values that can | Text, single-line |
| | be used to enter data into the field. Corresponds | (copy over values) |
| | to the SPFieldChoice class and to the Choice | |
| | field type that is specified on the Field element. | |
| Boolean | Specifies Boolean values that are stored in the | Flag |
| | database as 1 or 0. Corresponds to the | |
| | SPFieldBoolean class and to the Boolean field | |
| | type that is specified on the Field element. | |
| Number | Specifies floating point numbers. Corresponds to | Number |
| | the SPFieldNumber class and to the Number field | |
| | type that is specified on the Field element. | |
| Currency | Specifies currency values formatted based on a | Cost |
| | specific locale. Corresponds to the | |
| | SPFieldCurrency class and to the Currency field | |
| | type that is specified on the Field element. | |
| URL | Specifies hyperlinks. Corresponds to the | Text, single-line |
| | SPFieldUrl class and to the URL field type that is | |
| | specified on the Field element. | |
| User | Specifies users of a SHAREPOINT site. | Text, single-line |
| | Corresponds to the SPFieldUser class and to the | |
| | User field type that is specified on the Field | |
| | element. | |
| Lookup | Specifies references to values in other lists. | Text, single-line |
| | Corresponds to the SPFieldLookup class and to | |
| | the Lookup field type that is specified on the | |
| | Field element. | |
| MultiChoice | Specifies multiple values per list item. | Text, single-line, |
| | Corresponds to the SPFieldMultiChoice class and | (separate values by |
| | to the MultiChoice field type that is specified on | semicolons) |
| | the Field element. | |
| UserMulti | Same as User, but supports multiple selections. | Text, single-line |
| | Parent field type is LookupMulti. | (separate multiple |
| | | values by semicolons) |
| LookupMulti | Like Lookup, but supports multiple selections. | Text, single-line |
| | Parent field type is Lookup. | (copy over the values, |
| | | using |
| | | SPFieldLookupValue, |
| | | separated by |
| | | semicolons) |
| Calculated | Specifies calculated values. Corresponds to the | Text, single-line |
| | SPFieldCalculated class and to the Calculated | (copy over value) |
| | field type that is specified on the Field element. | |
| ContentTypeId | Specifies a content type ID. Corresponds to the | Text, single-line |
| | ContentTypeId field type that is specified on the | |
| | Field element. | |
| Guid | Specifies GUIDs. Corresponds to the Guid field | Text, single-line |
| | type that is specified on the Field element. | |

As described above, execution of a workflow can be used to call a create project from list item action using the collaborative server 308, a PSI call, and/or a mapping database. A create project from list item action (e.g., CreateProjectFromListItem) of an embodiment uses a project type GUID parameter and includes a main workflow activity that operates to create a project from a collaborative list item, such as an ideas list item. For example, an enterprise project type (EPT) globally unique identifier (GUID) can be used when creating the new project from an idea stored as a list item.

The table below lists examples of mapping parameters used in part to maintain mapping information between collaborative list items and corresponding projects. The mapping information can be stored in a dedicated repository, remotely, and/or locally to serve respective collaborative and project systems. As shown as an example in the table below, three exemplary mappings can be used between entities in a SHAREPOINT list and project server.

| From | To | Storage Location | Use Case |
|---|---|---|---|
| SHAREPOINT list | project server | List metadata in | When promoting list items |
| column | field (intrinsic | SHAREPOINT | to projects, use the mapping |
| | field or Enterprise | | to copy over values |
| | Custom Field) | | |
| SHAREPOINT list | project server | Hidden column in | To link to the project from |
| item | project | the list | the list, and when editing |
| | | | project server fields through |
| | | | workflow, to know which |
| | | | project to update |
| project server project | SHAREPOINT | A new column in | To link to the list from the |
| | list item | the | project, and when editing |
| | | MSP_PROJECTS | list fields through a project |
| | | table | workflow, to know which |
| | | | item to update |

For this example, as part of the mapping of SHAREPOINT list items to project server projects, when a list item is promoted to a project, a resulting project's GUID can be stored in a hidden column in the list. In one embodiment, if the column has a value in it, then the list item is considered promoted and precluded from being promoted again unless other circumstances occur. In an embodiment, when a list item is promoted, use a return value of a create project call as the project identifier (e.g., the project's GUID), and store that value in a project web access project ID (PwaProjectID) column in the list.

If the project web access project ID column does not exist for the list, then a new column can be created for the list with the properties shown in the table below, where the new project's GUID can be saved.

| | Display | | Additional | |
|---|---|---|---|---|
| Name | Name | Type | Properties | Purpose |
| PwaProjectID | project | Guid | Hidden = “TRUE” | Stores the GUID of the project |
| | web | | Default | created from this item, |
| | access | | Value = <blank> | corresponding to |
| | Project ID | | | MSP_PROJECTS.PROJ_UID |

Continuing the example, as part of the mapping project server projects to SHAREPOINT list items, when a list item is promoted to a project, the list item's ID can be stored in the corresponding project table (e.g., MSP_PROJECTS table), and the list item ID can be passed as part of a create project call.

The table below lists exemplary columns that can be included as part of a project table (e.g., MSP_PROJECTS) table, having the exemplary properties shown.

| | | Allow | Default | |
|---|---|---|---|---|
| Column Name | Data Type | Nulls | Value | Purpose |
| SP_IDEA_LIST_SITE_NAME | nvarchar(260) | Yes | NULL | Stores the relative |
| | | | | URL to the |
| | | | | subsite containing |
| | | | | the Ideas List |
| SP_IDEA_LIST_ID | uniqueidentifier | Yes | NULL | Stores the GUID |
| | (UID) | | | of the Ideas List, |
| | | | | corresponding to |
| | | | | SPList.ID |
| SP_IDEA_LISTITEM_ID | uniqueidentifier | Yes | NULL | Stores the GUID |
| | (UID) | | | of the list item |
| | | | | that was the |
| | | | | source for the |
| | | | | new project, |
| | | | | corresponding to |
| | | | | SPListItem.ID |

A user can use functionality described herein to define a mapping between list columns and project fields of a project web access, including intrinsic fields and enterprise custom fields, wherein the mapping can be used when creating a new project from a list item and/or when updating project and list item parameters. A mapping definition of an embodiment can be configured as a one-way mapping (e.g., from list column to project web access field) that allows mapping to all fields defined in project web access, and stored in the collaboration server 308 as a property on the list itself. If a column maps to a project web access intrinsic field, the name of the field can be stored corresponding to a column name in the MSP_PROJECTS table. If the column maps to an enterprise custom field, the GUID of the custom field can be stored (e.g., MSP_CUSTOM_FIELDS.MD_PROP_UID). As described above, a mapping method can be used as part of storing an XML fragment of all mappings as a property on a list.

An exemplary UI can be used to access a page in list settings where users can go to create, view, and manage a column-field mapping. Once the mapping feature is enabled on the list, a new link can be added to the “General Settings” heading called “project server settings” using a SHAREPOINT custom action for example.

| String | Link location |
|---|---|
| project server | ~site/_layouts/PwaSettings.aspx?List={List GUID} |
| settings | |

The exemplary link can be used to load a custom project server settings page (e.g., “PwaSettings.aspx”) and enables the user to manage and configure the mapping between list columns and project fields (e.g., project web access fields). The link uses a list GUID as a parameter to show the proper content for a selected list. In an embodiment, a page can be displayed including showing all the columns in a list, wherein a user can select fields of a project or projects that map to each column. The page can be configured to check for a new project permission for the user, and an error message can be displayed if the user doesn't have that permission.

If the user does have permission, encoded instructions can be used to get a list of columns on the list for display with their display name and data type, one per row, including intrinsic and/or custom fields. A first “Type” column is the data type of the SHAREPOINT column, using the display name of SPField.TypeDisplayName (e.g. “Single line of text”, “Date & Time”, “Person or Group” . . . ). The instructions can be encoded to not perform validation on the page until the user affirmatively acts (e.g., clicks “OK”). An error message can be displayed if any field is double-mapped to more than one column.

If the user doesn't have permission to see a list of custom fields, then only the set of intrinsic fields can be used/shown. If there is an existing mapping on the list that includes custom fields, and a user without permissions loads the page, then a process operates to show blank values for any columns that map to custom fields. The user can also cancel out of the page and maintain the existing mapping. As described briefly above, permissions allowing use of the button can be checked in the page itself. For example, the button can be hidden, grayed-out, or otherwise disabled for users who do not have Manage Lists permissions. The buttons can be enabled when items in a view are selected (e.g., one or multiple).

The table below lists a number of exemplary collaborative and project server mapping field types that can be used in various embodiments described herein.

| Collaborative | | |
|---|---|---|
| Server Field | | |
| Type | Description | Default project server field type |
| Integer | Specifies positive or negative integer | Number |
| | values. Corresponds to the Integer field | |
| | type that is specified on the Field | |
| | element. Value = 1. | |
| Text | Specifies a single line of text. | Text, single-line |
| | Corresponds to the SPFieldText class | |
| | and to the Text field type that is | |
| | specified on the Field element. Value = 2. | |
| Note | Specifies a field that can contain | Text, multi-line |
| | multiple lines of text. Corresponds to | |
| | the SPFieldMultiLineText class and to | |
| | the Note field type that is specified on | |
| | the Field element. Value = 3. | |
| DateTime | Specifies date and time values. | Date |
| | Corresponds to the SPFieldDateTime | |
| | class and to the DateTime field type | |
| | that is specified on the Field element. | |
| | Value = 4. | |
| Choice | Specifies a predetermined set of values | Text, single-line (copy over the |
| | that can be used to enter data into the | values) |
| | field. Corresponds to the | |
| | SPFieldChoice class and to the Choice | |
| | field type that is specified on the Field | |
| | element. Value = 6. | |
| Boolean | Specifies Boolean values that are stored | Flag |
| | in the database as 1 or 0. Corresponds | |
| | to the SPFieldBoolean class and to the | |
| | Boolean field type that is specified on | |
| | the Field element. Value = 8. | |
| Number | Specifies floating point numbers. | Number |
| | Corresponds to the SPFieldNumber | |
| | class and to the Number field type that | |
| | is specified on the Field element. | |
| | Value = 9. | |
| Currency | Specifies currency values formatted | Cost (copy over the value, |
| | based on a specific locale. Corresponds | ignoring the locale ID) |
| | to the SPFieldCurrency class and to the | |
| | Currency field type that is specified on | |
| | the Field element. Value = 10. | |
| URL | Specifies hyperlinks. Corresponds to | Text, single-line |
| | the SPFieldUrl class and to the URL | |
| | field type that is specified on the Field | |
| | element. Value = 11. | |
| User | Specifies users of a SHAREPOINT | Text, single-line |
| | site. Corresponds to the SPFieldUser | |
| | class and to the User field type that is | |
| | specified on the Field element. Value = 20. | |
| Lookup | Specifies references to values in other | Text, single-line (copy over the |
| | lists. Corresponds to the | value, using |
| | SPFieldLookup class and to the | SPFieldLookupValue) |
| | Lookup field type that is specified on | |
| | the Field element. Value = 7. | |
| MultiChoice | Specifies multiple values per list item. | Text, single-line (separate values |
| | Corresponds to the | by semicolons) |
| | SPFieldMultiChoice class and to the | |
| | MultiChoice field type that is specified | |
| | on the Field element. Value = 15. | |
| UserMulti | Same as User, but supports multiple | Text, single-line (separate |
| | selections. Parent field type is | multiple values by semicolons) |
| | LookupMulti. | |
| LookupMulti | Like Lookup, but supports multiple | Text, single-line (copy over the |
| | selections. Parent field type is Lookup. | values, using |
| | | SPFieldLookupValue, separated |
| | | by semicolons) |
| Calculated | Specifies calculated values. | Text, single-line (copy over |
| | Corresponds to the SPFieldCalculated | value) |
| | class and to the Calculated field type | |
| | that is specified on the Field element. | |
| | Value = 17. | |
| ContentTypeId | Specifies a content type ID. | Text, single-line |
| | Corresponds to the ContentTypeId field | |
| | type that is specified on the Field | |
| | element. Value = 25. | |
| Guid | Specifies GUIDs. Corresponds to the | Text, single-line |
| | Guid field type that is specified on the | |
| | Field element. Value = 14. | |

Data types not useful or that do not correspond to a data type in the project server can be blocked. The following table provides a number of exemplary mapping scenarios handled accordingly.

| | |
|---|---|
| Column added | Not mapped by default. The user can come |
| | back to the mapping page and map the new |
| | column to a field in project web access |
| Column modified | No change to mapping. If the changes are |
| | “non-fatal changes” (such as renaming the |
| | column), just continue to work as before. If |
| | the changes are “fatal changes” (such as |
| | changing the data type to an incompatible |
| | type with the mapped project web access |
| | field), fail |
| Column deleted | Since the mapping is stored on the column, |
| | this will automatically remove the mapping |
| | as well. |
| Field added | The field will now be available as a target for |
| | mapping the next time the user visits the |
| | mapping page |
| Field modified | No change to mapping. If changes are “non- |
| | fatal”, continue to work. If the changes are |
| | “fatal”, then fail. |
| Field deleted | Revert to a blank mapping the next time the |
| | user visits the mapping page. |

As described above, collaborative list items, including data and metadata, can be used to create projects, including manual creation (e.g., using SHAREPOINT UI) functionality, and automated creation functionality based in part on the use of an encoded workflow associated with a designated items of a collaborative list (e.g., an Ideas List). Mapping information and/or settings are used in part to create a new project from a collaborative list item, wherein a project creation process of one embodiment includes copying over the correct values according to the mapping, storing an identifier (e.g., GUID) of the collaborative list item in the new project, and/or storing an identifier (e.g., GUID) of the new project as part of the collaborative list item.

As an example, of a new project creation process, when a collaborative list item is used to create a project, a collaborative system can operate to create a new column in the associated collaborative list to store a status of the collaborative item tracking aspects of the new project. The table below shows exemplary column properties that can be used.

| | Display | | |
|---|---|---|---|
| Name | Name | Type | Purpose |
| PwaProjectStatus | Project | Text | Stores an arbitrary text status of the |
| | Web App | | project, as set by the result of the |
| | Project | | CreateProject call, or through the |
| | Status | | UpdateIdeaListItemStatus |
| | | | workflow action. |

The table below shows a number of exemplary default values used to populate the field to indicate that the project was promoted. The value can be overwritten once a project manager uses the UpdateIdeaListhemStatus workflow action on the new project.

| Case | Default Value |
|---|---|
| Project creation queued successfully | Project creation queue |
| Project Creation Success | Project created |
| Project Creation Failed | Project creation failed |

As an example, when a Create Projects button is clicked, the UI can be configured to show a progress bar or waiting icon, and update all the field mappings with newly selected values if changed. Moreover, for each selected list item, the progress indicator text can be updated with a new item number, create a new project in the project server 306 based in part on a selected project or template type, save a collaborative list item GUID to the project (e.g., stored on the project server), and save the project GUID to the list item as stored in the collaborate server 308. If a mapping exists for a given column, a copy operation copies over the value into the correct field of the new project.

As described above, projects can also be created automatically based in part on a workflow action included with a collaborative list. For example a workflow action can be provided to create a new project in project web access that users can include as part of a list-based workflow. Since the action is part of a list item workflow, the action operates to create a single project at a time based in part on a workflow context. The table below list exemplary properties of the workflow action.

| Workflow Action Name | Parameter | Parameter Type |
|---|---|---|
| Create Project from List | Enterprise Project Type | Guid |
| Item | GUID | |

In an embodiment, a workflow action can use a project type GUID (e.g., EPT GUID) as a parameter and, when executed, operate to create a new project with the selected project type, save the list item GUID to the project, save a project GUID to a collaborative list item, read the column-field mapping, and copy over values for each mapped column. If no mapping exists, default to limiting the mapping of a Title column of the collaborative list to a Project Name field in the project server.

In an embodiment, once a project or projects are created based upon one or more collaborative lists, fields in each project can be updated based in part a list item workflow. For example, an UpdateProjectProperty workflow action can be used to update fields in the associated project from the list item workflow. A list-based workflow action can read the PwaProjectID column as part of updating the correct project in project server 306. As an example, using an update idea list item property workflow action (e.g., UpdateIdeaListItemProperty workflow action), users can update fields in a collaborative ideas list using a project-based workflow. When used in the context of a project-based workflow, the action can operate to read the project-related column (e.g., SP_IDEA_LISTITEM_ID column) from the corresponding project as part of updating the correct list item in the collaboration server 308.

As part of exposing manual and automatic project creation features in a collaborative list, a functional computer application can be installed, such as a project web application and/or collaborative list-project cross-functionality application to a site, such as part of providing a computing server farm. In an embodiment, the following functionality can be encoded with or added to all lists in a particular site, including, but not limited to providing a project server settings page under List Settings and/or new ribbon interface buttons. As an example, a SHAREPOINT application can be built to expose any part of or all of the functionality to a site, and requires that a project server or application be installed as a prerequisite. As another example, the functionality can be shipped as a SHAREPOINT feature that users can enable on a particular site.

The table below shows example logging properties for the create project from list item functionality.

| Event | Messages | Placeholders |
|---|---|---|
| Create project from list | Creating project from list item | {0}—list item ID |
| item | with ID {0}, EPT {1} | {1}—EPT GUID |
| Successfully copying over | Copying value from column | {0}—column internal name |
| a column's value | “{0}” to field “{1}” | {1}—custom field GUID, or |
| | | intrinsic field name |
| Failure copying a | Failed to copy value from | {0}—failed column internal |
| column's value | column “{0}” for list item {1}: | name |
| | {2} | {1}—list item ID |
| | | {2}—any relevant error |
| | | message details |
| Item was promoted | A project already exists for list | {0}—list item ID |
| already | item with ID {0}, skipping it. | |
| Create project success | Project successfully created for | {0}—list item ID |
| | list item {0}, project GUID: {1} | {1}—new project GUID |
| Create project failure | Failed to create project for list | {0}—list item ID |
| | item {0}: {1} | {1}—any relevant error |
| | | message details |
| Can't reach project web | Could not connect to the Project | {0}—PSI URL |
| access service | Service at {0}. | |
| List or list item doesn't | The list item with ID {0} and | {0}—list item ID |
| exist (for | list ID {1} does not exist, and | {1}—list ID |
| UpdateIdeaListItemStatus) | its status was not updated. It | |
| | may have been deleted by | |
| | another user. | |
| Project doesn't exist (for | The project with GUID {0} | {0}—project GUID |
| UpdateProjectProperty) | does not exist, and was not | |
| | updated. It may have been | |
| | deleted by another user. | |
| Couldn't save column | Could not save the mapping | {0}—any relevant error |
| mapping | between SHAREPOINT | message details |
| | columns and project server | |
| | fields: {0} | |
| Couldn't save new project | Could not save new project | {0}—new project GUID |
| GUID to the list item | GUID {0} to the list item {1}: | {1}—list item ID |
| | {2} | {2}—any relevant error |
| | | message details |

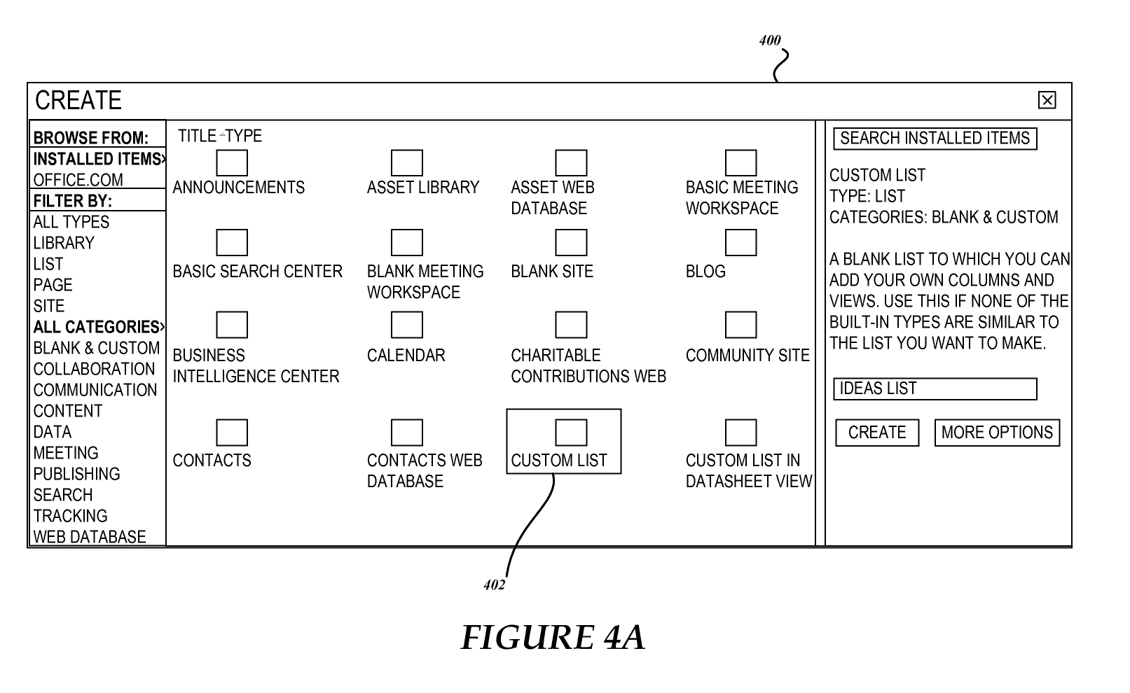

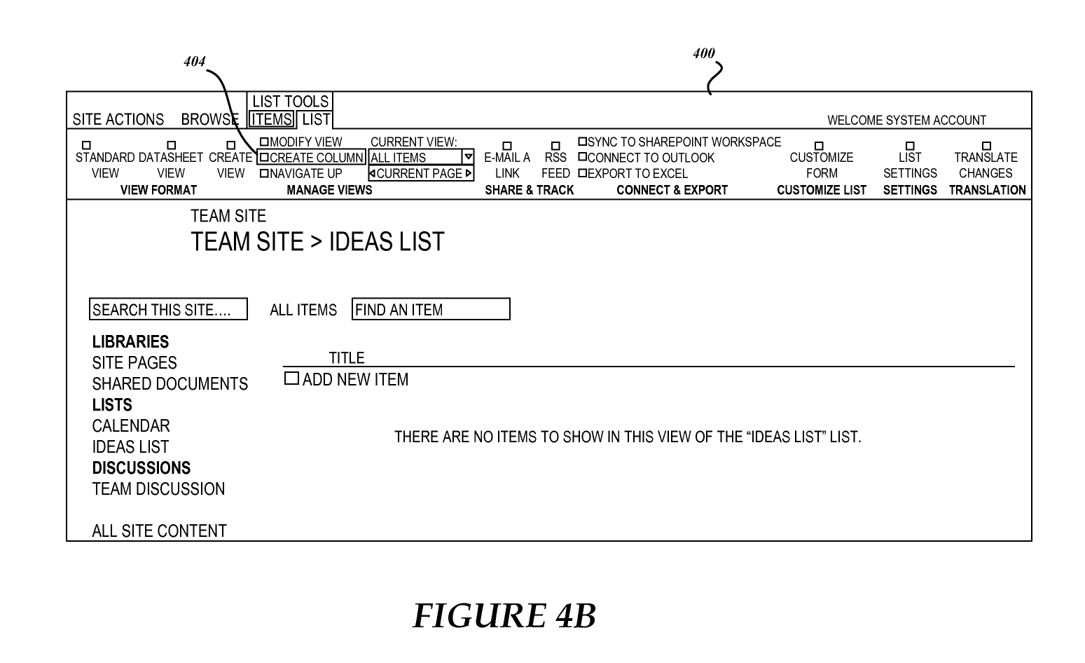

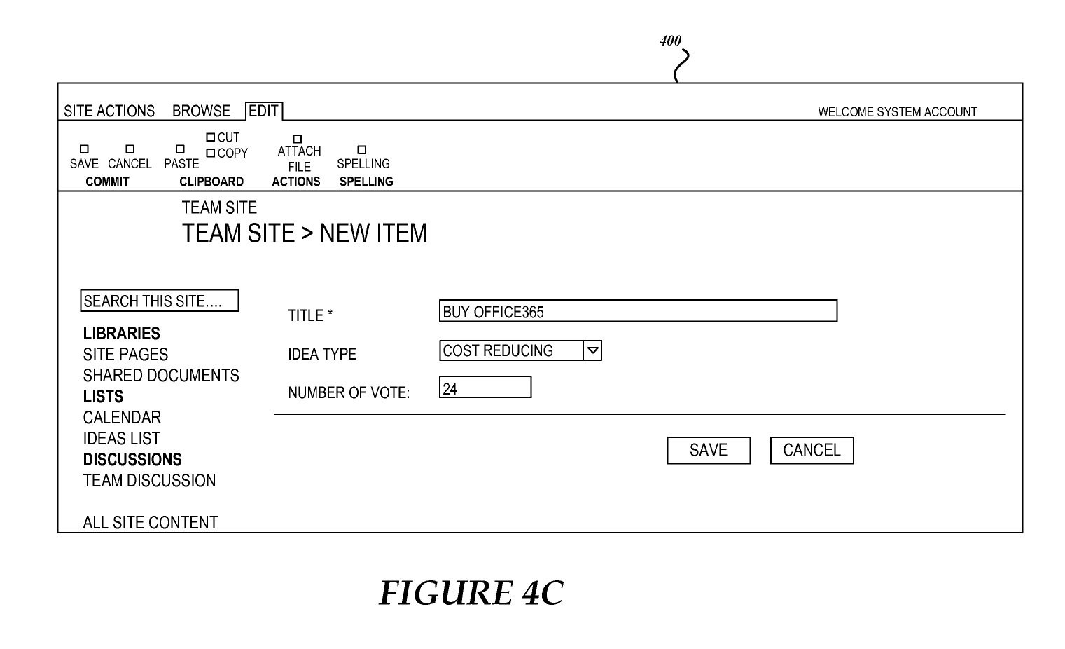

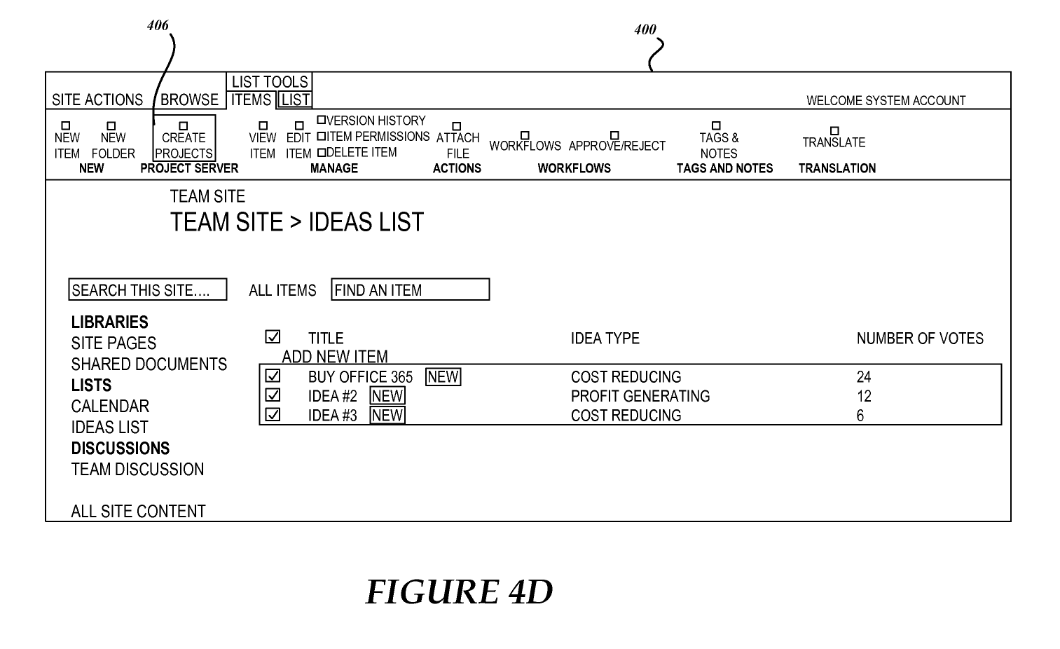

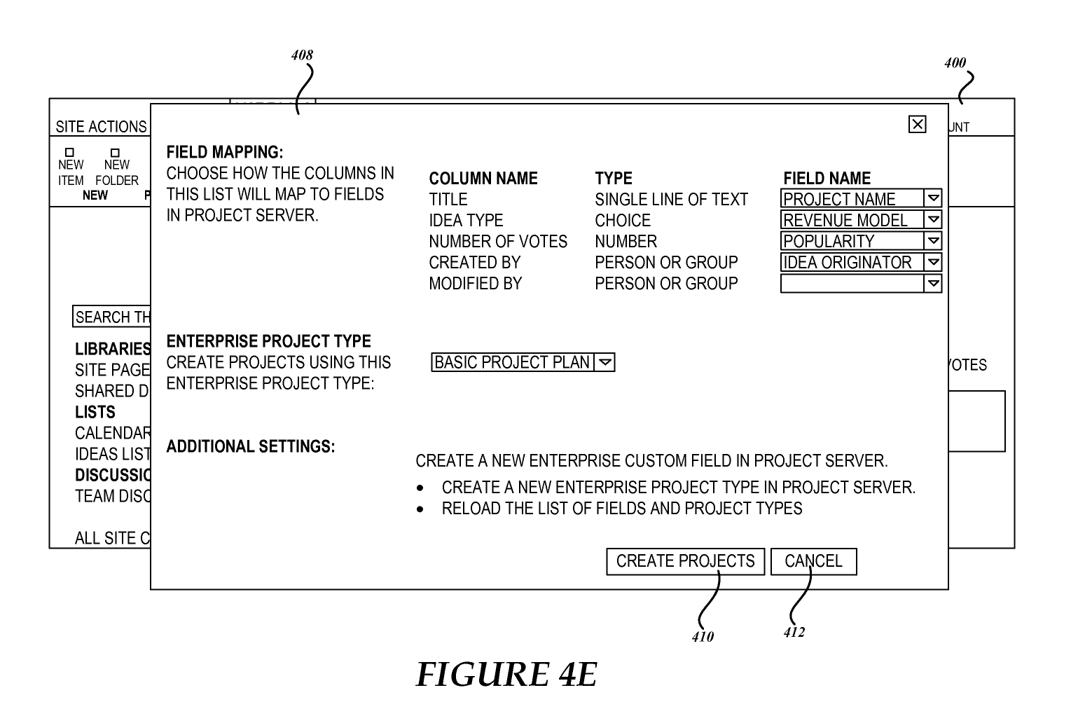

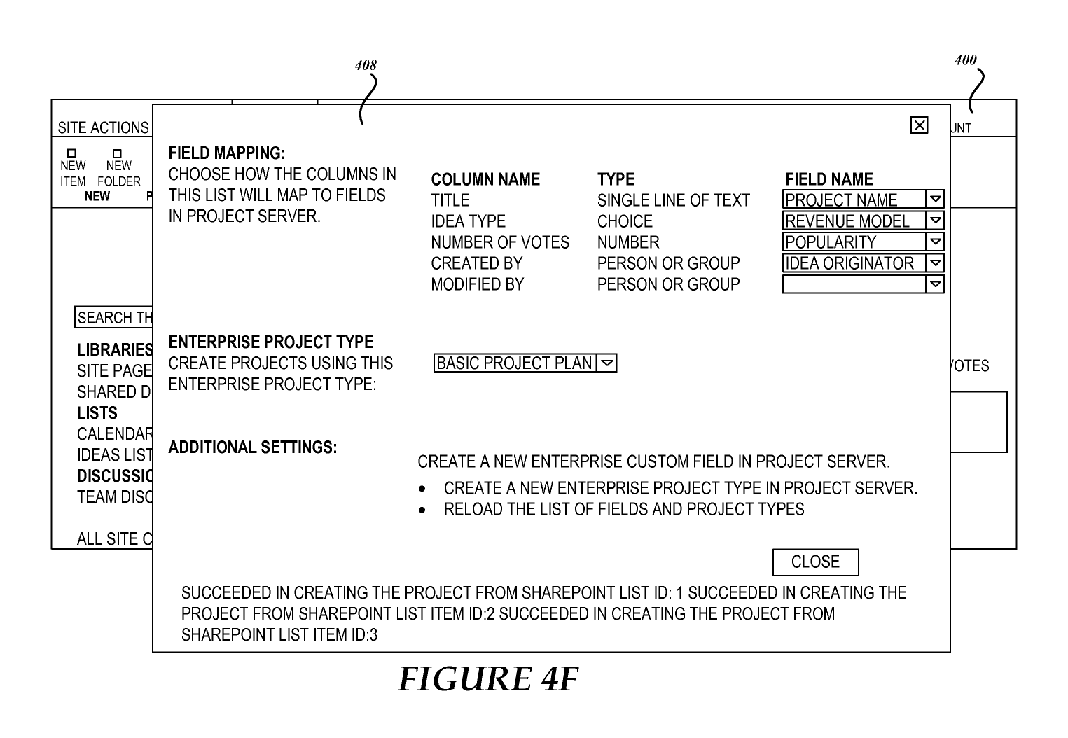

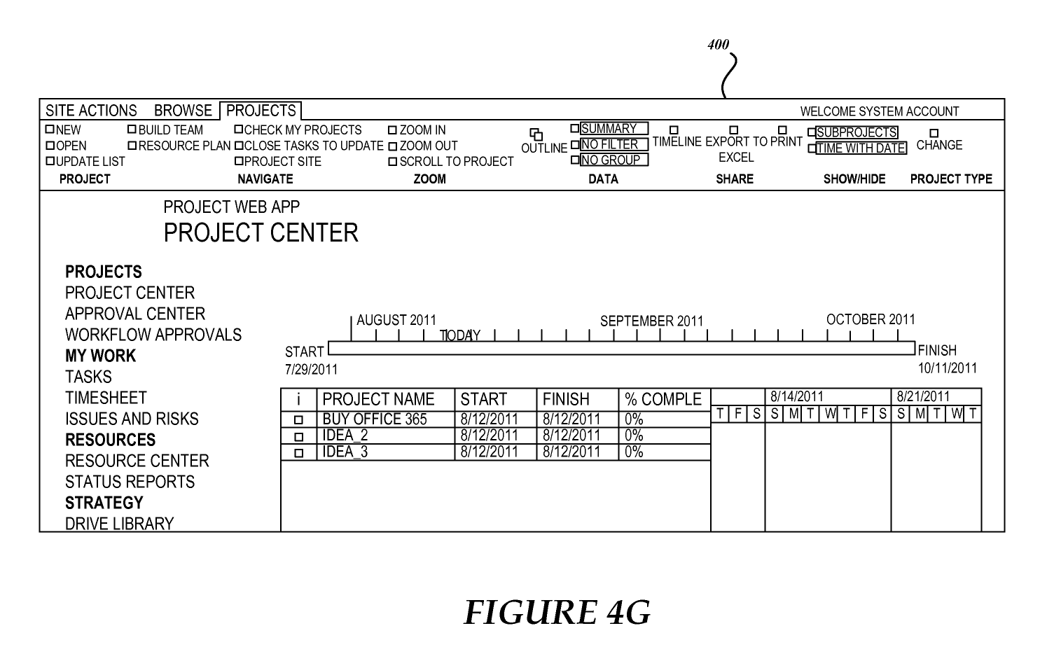

FIGS. 4A-4G depict an example UI 400 that can be used as part of creating projects from list items. A user can use the UI 400 to promote collaborative list items by manually selecting one or more items in a list view and clicking the “Create Projects” button or interface 406 in the Items tab of the ribbon. A dialog enables a user to specify the column-field mapping and an enterprise project type to use, after which the projects are automatically created for the selected items. Additionally, collaborative list items can be promoted automatically using a workflow action. For example, a user can set up a workflow on a SHAREPOINT list, using a project creation action (e.g., Create Project from List Item action) as part of the workflow. The action uses an enterprise project type ID as a parameter, and, when executed, uses mapping information in part to create a project in a project server from the context of a current list item. Once a project is created in a project server, manually or automatically, encoded instructions can be used to persist a link between each list item and the corresponding project.

In an embodiment, several restrictions can be enforced, such as: creating one project per list item, and once a list item is promoted to a project, store the project GUID in a hidden column on the list, including preventing creation of another project from the same list item. However, if the user deletes the value in that column, another project can then be created from the list item. In an alternative embodiment, project fields can be updated after an initial creation using a project property workflow action (e.g., the UpdateProjectProperty) that can be provided as a regular list workflow. A project service instance can be used for the site collection that the Ideas List lives in/resides which prevents cross-site collection actions. A project queue can be configured to handle throttling of requests as necessary.

As a use example, a project manager accesses a collaborative system using a browser-based application, including those used for desktop, laptop, tablet, and/or smartphone type devices/systems, and creates a collaborative list (e.g., a SHAREPOINT list for ideas), configured according to a particular idea collaboration process. In an embodiment, once a decision is made to grow items of the collaborative list into project server projects, the described features and functionality can be exposed (e.g., using an add-in, accessing isolated code, etc.). In an alternative embodiment, a user can access a project server settings page in List Settings, and set up any mapping from columns of the list to encoded fields of a project server.

FIG. 4A depicts the exemplary UI 400 including an interface 402 that enables a user to create a custom list. For example, the user can use the UI 400 to create a new collaborative list or access an existing list.

FIG. 4B depicts the UI 400 including a create column interface 404 that the user can use to add columns that store metadata and/or information about each list item or idea for this example.

FIG. 4C depicts the UI 400 after the user has added information about a new list item, such as a title, an idea type, and a number of votes. As an example, a user can create an “Ideation Portal” for users to submit, comment, rate, discuss, and vote on ideas (e.g., using default SHAREPOINT customization features).

FIG. 4D depicts the UI 400 after a user has selected several items in the list and clicked a Create Projects interface 406 in the ribbon. In accordance with an embodiment, at this point, the list item to project code connects to a project server and retrieves a list of custom fields and/or enterprise project types.

FIG. 4E depicts the UI 400 including a dialog 408 that a user can use to map the fields from a collaborative list to custom fields defined in the project server, and choose an enterprise project type to be used for the new projects. The dialog 408 includes a create projects interface 410 and a cancel interface 412. For example, in a project web application, an enterprise project type can be used to represent a wrapper that encapsulates phases, stages, a single workflow, and/or project detail pages and represent a single project type. Enterprise project types can be displayed in a drop-down list of project types.

FIG. 4F depicts the UI 400 after a user has clicked the create projects interface 410. At this point, the project creation code saves the currently selected field mapping as the default for the list, such that the next time a user selects a few list items and clicks create projects interface 406 in the ribbon, it defaults to this field mapping, and loops over the set of selected list items. For each of the selected list items, the project creation code creates a new project in the project server with a specified project type, sets the new project's custom field values according to the field mapping, and/or sets a few hidden fields in the list and a project server database, linking the list item to the new project. For this example, the mapping resulted in the project's “Revenue Model” field being set to the value of the “Idea Type” column from the list item.

FIG. 4G depicts the UI 400 connected to the project server to show the newly created projects that can be used for tracking and/or execution of the ideas that were suggested in the collaboration server.

While certain embodiments are described herein, other embodiments are available, and the described embodiments should not be used to limit the claims. Exemplary communication environments for the various embodiments can include the use of secure networks, unsecure networks, hybrid networks, and/or some other network or combination of networks. By way of example, and not limitation, the environment can include wired media such as a wired network or direct-wired connection, and/or wireless media such as acoustic, radio frequency (RF), infrared, and/or other wired and/or wireless media and components. In addition to computing systems, devices, etc., various embodiments can be implemented as a computer process (e.g., a method), an article of manufacture, such as a computer program product or computer readable media, computer readable storage medium, and/or as part of various communication architectures.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of device.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

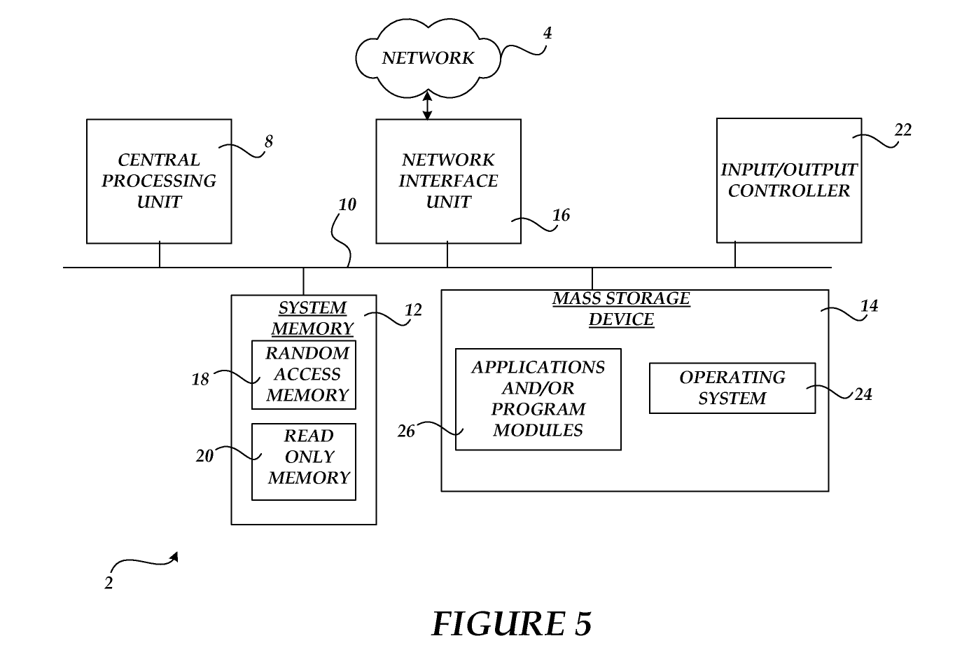

Referring now to FIG. 5, the following discussion is intended to provide a brief, general description of a suitable computing environment in which embodiments of the invention may be implemented. While embodiments of the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the embodiments of the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 5, an illustrative operating environment for embodiments of the invention will be described. As shown in FIG. 5, computer 2 comprises a general purpose server, desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method comprising:
using a collaborative list including a number of list items having fields of associated data types;
validating that a list item has not already been promoted to a project;
generating a project data set to be used to create a new project including setting up links to list item parameters used to generate the new project, analyzing mapping information for an associated list or list item, and checking a data type of each project field based in part on corresponding list item data types; and
calling a project publishing method in part to create the new project.

2. The method of claim 1, further comprising storing the mapping information in the collaborative list, enabling manual creation of a plurality of new projects based in part on a plurality of list items, and enabling generation of new project data using a list-based workflow.

3. The method of claim 1, further comprising generating mapping information based in part on the use of a web identifier (ID), collaborative list ID, list item ID, and/or a corresponding project type ID.

4. The method of claim 1, further comprising using the list item parameters including a web identifier, a list identifier, and a list item identifier as part of providing granular control over which items become new projects.

5. The method of claim 1, further comprising generating the project data set including converting each list item based in part on an associated data type and ensuring that a new project name is unique.

6. The method of claim 1, further comprising writing a resulting project identifier to a corresponding list item based in part on a new project workflow.

7. The method of claim 1, further comprising updating the mapping information including updating a project field data type from a first type to a second type corresponding to a changed list item data type.

8. The method of claim 1, further comprising calling a project queuing method with the publishing method to create a project object in a project server.

9. The method of claim 1, further comprising using a collaboration system to manage the collaborative list and a project server to manage new projects created from the list items, and communicating list-project changes to one or more of the collaboration system and the project server.

10. The method of claim 1, further comprising updating a project field based in part on a list item workflow.

11. The method of claim 1, further comprising creating the new project in a project server including using a project type value, setting custom field values of the new project according to field mapping parameters, setting one or more hidden fields in the collaborative list, and linking the list item to the new project.

12. The method of claim 1, further comprising using properties associated with a project web access ID, list ID, and list item ID to access a target list and list item as part of setting an idea list item status value.

13. The method of claim 1, further comprising automatically updating a project status column in the collaborative list using a workflow running on the new project.

14. The method of claim 1, further comprising automatically updating the list item using a custom status specified by a project workflow author.

15. A system comprising:
a project server to create and manage projects; and
a collaboration server including:
a number of collaborative lists, each collaborative list including a number of list items; and
a project creation component configured in part to create projects from specified list items, including creating a new project for each selected list item based in part on list item to project field mappings.

16. The system of claim 15, the project creation component further configured to generate, store, and/or manage list item to project field mappings.

17. The system of claim 15, the project server further configured to use a mapping database to identify a list item ID associated with a given project to push project data to the corresponding collaborative list.

18. Computer storage, including instructions which, when executed, operate to:
generate a project field mapping for a list;
use a list workflow that includes a create project from list item action;
select a project type to use with the list, wherein the project type is a parameter of the create project from list item action; and
execute the list workflow for new list items including using the create project from list item action to start a process to create the project and set project field values based in part on the project field mapping and a list item type.

19. The computer storage of claim 18, including instructions which, when executed, operate to create a new project based in part on submitted ideas contained as part of a collaborative electronic list.

20. The computer storage of claim 18, including instructions which, when executed, operate to update a list item using a project workflow.
